(19) United States
(12) Patent Application Publication
(10) Pub. No.: US 2021/0049588 A1
(43) Pub. Date: Feb. 18, 2021

(54) SYSTEMS AND METHODS FOR USE IN PROVISIONING TOKENS ASSOCIATED WITH DIGITAL IDENTITIES

(71) Applicant: MASTERCARD INTERNATIONAL INCORPORATED, Purchase, NY (US)

(72) Inventors: Ashfaq Kamal, Stamford, CT (US); Charles Walton, Marshfield, MA (US); Liang Tian, Rye Brook, NY (US)

(21) Appl. No.: 16/991,387

(22) Filed: Aug. 12, 2020

Related U.S. Application Data
(60) Provisional application No. 62/886,032, filed on Aug. 13, 2019.

(51) Int. Cl. G06Q 20/36; H04L 9/32; G06Q 30/00; G06Q 20/40; G06Q 20/38

(52) U.S. Cl. CPC G06Q 20/3674; H04L 9/3221; H04L 9/3213; H04L 9/3231; G06Q 20/363; G06Q 20/3672; G06Q 20/40145; G06Q 20/3827; G06Q 30/0185

(57) ABSTRACT

Systems and methods are provided for use in tokenizing credentials for users. One exemplary computer-implemented method includes receiving a tokenization request including a first biometric template for a user, deriving a zero-knowledge proof (ZKP) parameter based on the first biometric template and an identifier associated with the user, and storing the ZKP parameter in a ledger data structure. The method then includes receiving an authentication request for a transaction by the user at a merchant, where the authentication request includes the identifier, generating a subsequent ZKP based on a second biometric template associated with the user and the identifier included in the authentication request, checking the subsequent ZKP against the ZKP parameter stored in the ledger data structure, and transmitting a verified identifier for the user to an authorization network when the check of the subsequent ZKP is successful.

### CROSS-REFERENCE TO RELATED APPLICATION

This application claims the benefit of, and priority to, U.S. Provisional Application No. 62/886,032 filed on Aug. 13, 2019. The entire disclosure of the above-referenced application is incorporated herein by reference.

### FIELD

The present disclosure is generally directed to systems and methods for use in provisioning tokens, associated with digital identities of users, to platforms and/or communication devices, and use of the tokens in authenticating the users.

### BACKGROUND

This section provides background information related to the present disclosure which is not necessarily prior art.

Users are known to interact with various entities through various channels, whether in person at brick and mortar locations or through online locations (e.g., through websites, etc.). In connection therewith, the users provide credentials (e.g., account numbers, verification codes (e.g., card verification codes (CVCs), etc.), expiration dates, etc.) to the entities, by which account transactions are initiated. The credentials may be in the form of tokens in certain instances, provisioned to applications associated with the users or with the online locations, whereby the tokens are then used in lieu of the actual credentials associated with the users' accounts to initiate the transactions and whereby the actual credentials are obscured from the entities involved in the transactions.

### DRAWINGS

The drawings described herein are for illustrative purposes only of selected embodiments and not all possible implementations, and are not intended to limit the scope of the present disclosure.

FIG. 1 illustrates an exemplary system of the present disclosure suitable for use in enabling payment tokens to be provisioned to users in connection with digital identities;

FIG. 2 is a block diagram of a computing device that may be used in the exemplary system of FIG. 1;

FIG. 3 illustrates an exemplary method, which may be implemented in connection with the system of FIG. 1, to provision a digital identity token for a user to a ledger data structure; and

FIG. 4 illustrates an exemplary method, which may be implemented in connection with the system of FIG. 1, for use in authenticating a user in connection with a network transaction.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Users who purchase products and/or services from merchants via online platforms (e.g., merchant websites, etc.) may employ payment tokens, in lieu of primary account numbers (PANs) for their payment accounts, to initiate transactions for the products and/or services in order to provide enhanced security. These tokens may be provisioned to the users, per merchant, and replaced in situations of fraud, while leaving the PANs valid and usable in payment account transactions. However, authentication of the users may be problematic in connection with provisioning the payment tokens to communication devices (e.g., to virtual wallet applications, etc.) or to merchant online platforms (e.g., merchant websites, etc.), and further using the payment tokens provisioned thereto may be difficult.

Uniquely, the systems and methods herein enable payment tokens to be provisioned to users in connection with (or through use of) their digital identities. In particular, in response to a tokenization request by a user for a payment account, a digital identity provider receives a hashed biometric template for the user, via an enhanced authentication platform, and verifies the user associated with the hashed biometric template. When verified, the digital identity provider derives and stores one or more zero-knowledge proof parameters as an entry in a ledger data structure (e.g., a Blockchain data structure in memory, etc.), and then provides an identifier associated with the entry, whereby a token may be provisioned to a communication device associated with the user or to a transaction interface (e.g., a merchant website, etc.). Thereafter, in connection with use of the token in a network transaction (e.g., at a merchant, etc.), the digital identity provider derives the one or more zero-knowledge proof parameters based on a hashed biometric template received in connection with a transaction request for the transaction and compares the parameters to those stored in the ledger data structure (via the enhanced authentication platform) which enables a strong verified identity designation to be included in (or appended to) the transaction request (e.g., by the merchant, etc.). In this manner, enhanced confidence in the authentication of the user in connection with the network transaction is provided to a relying party (e.g., an issuer of the payment account, etc.), while limiting sharing of specific identifying information of the user.

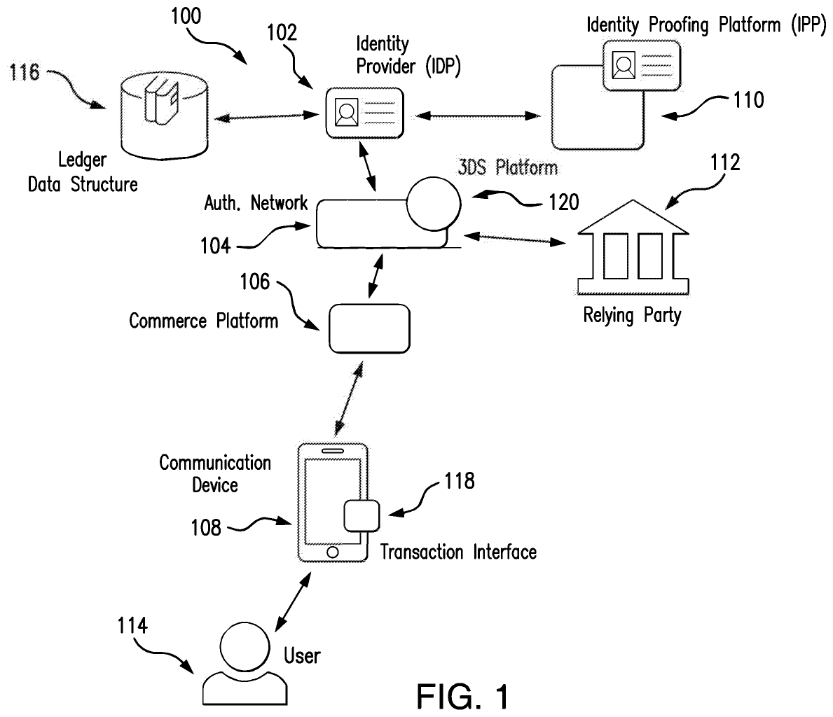

FIG. 1 illustrates an exemplary system 100 in which one or more aspects of the present disclosure may be implemented. Although the system 100 is presented in one arrangement, other embodiments may include the parts of the system 100 (or other parts) arranged otherwise depending on, for example, relationships between users and merchants and payment networks in the system, particular types of platforms utilized with digital identities, particular transaction interfaces presented to the users (or others), relationships between users and relying parties, privacy concerns and/or requirements, etc.

The illustrated system 100 generally includes a digital identity provider (IDP) 102, an authorization network 104, a commerce platform 106, a communication device 108, an identity proofing platform (IPP) 110, and a relying party 112, each of which is coupled to one or more networks to provide communication therebetween. The network(s) is/are indicated generally by arrowed lines in FIG. 1, and each may include one or more of, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof.

The IDP 102 in the system 100 generally is associated with forming and/or managing digital identities associated with users (e.g., user 114, etc.). In connection therewith, the IDP 102 is configured to participate in storing identity information associated with users and authenticating the users (or requests associated with the users) in connection with one or more relying parties, as required (such as relying party 112).

The authorization network 104 in the system 100 is configured to facilitate authorization of payment account transactions (broadly, network transactions) performed by consumers (including the user 114) at merchants. Specifically, in this exemplary embodiment, the authorization network 104 is configured to pass authorization messages (e.g., ISO 8583 messages, etc. via payment rails, etc.) between banking institutions, whereby the banking institutions are permitted to authorize the transactions. In connection therewith, the commerce platform 106 is configured to facilitate initiation of the payment account transactions. The transactions may be initiated, by the users, at websites of the merchants, via mobile wallets, where the commerce platform 106 (rather than the merchants) initiate the transactions by submitting the appropriate messaging to the authorization network 104 (directly, or via a third party (e.g., via a payment gateway, an acquiring bank, etc.)). In this exemplary embodiment, the commerce platform 106 includes a secure remote commerce (SRC) service and a digital enablement service (e.g., the Mastercard® MDES, etc.), etc., which are configured to cooperate to allow the commerce platform 106 to operate as described herein.

Each of the IDP 102, the authorization network 104 and the commerce platform 106 are illustrated in FIG. 1 as standalone, separate services and/or devices in the system 100. However, the IDP 102, the authorization network 104 and/or the commerce platform 106 may additionally, or alternatively, be incorporated in whole or in part with another party in the system 100, such as, for example, a payment network, a business entity, or a banking institution, etc. Specifically, for example, the IDP 102, the authorization network 104 and the commerce platform 106 may be included in the Mastercard® payment network, with each being implemented in one or more computing devices thereof. Additionally, it should be appreciated that while the IDP 102, the authorization network 104 and the commerce platform 106 are each illustrated via a single part of the system 100, the IDP 102, the authorization network 104 and/or the commerce platform 106, may be segregated (or divided) into multiple different entities and/or computing devices in other embodiments, with data being exchanged therebetween, so that the IDP 102, the authorization network 104 and/or the commerce platform 106, overall, is still configured to operate as described herein.

With continued reference to FIG. 1, the communication device 108 is associated with the user 114 and may include, for example, a portable communication device, such as a tablet, smartphone, personal computers, etc. The communication device 108 includes a transaction interface 118, which may include, in turn, a virtual wallet application installed and active in the communication device 108, or a network-enable interface associated with a merchant (e.g., a merchant website, a merchant specific application, etc.), or another suitable interface, through which a transaction may be initiated or requested. It should be appreciated that the user 114 is associated with a payment account (e.g., credit account, debit account, prepaid account, etc.) (as provided to the user 114 by an issuer of payment accounts, etc.), which may then be used to fund such transactions with one or more merchants through the transaction interface 118.

In addition in the system 100, the user 114 is associated with an identity, which includes one or more identity attributes, such as a name, a mailing address, a government ID number, an email address, a phone number, a birthdate, biometric (e.g., facial images, fingerprints, palm prints, etc.), a gender, an age, an eye color, account numbers, an employee identifier, and/or other information sufficient to distinguish the user 114 from other users. The identity of the user 114 may further include a digital identity of a device associated with the user 114, in some embodiments (e.g., electronic serial number (ESN), mac address, IP address, etc. of the communication device 108, etc.). The identity may be evidenced by one or more physical documents issued by an authority (e.g., a federal government (e.g., a passport, a social security card, etc.), an insurance provider, a telecommunication provider (e.g., a mobile network operator (or MNO), etc.), a department of motor vehicles (or DMV), or other trusted identity authority, etc.). The authority may be referred to herein as the IPP 110, in some embodiments, or may be accessible to the IPP 110 in other embodiments. The IPP 110 (as the authority or through communication with the authority) then is configured to respond to requests to verify the identity of the user 114, for example, based on information provided by a party requesting such verification (e.g., a requesting entity such as the IDP 102, etc.).

And, finally in the system 100, the relying party 112 includes a company, a business or another entity through which the user 114 is able to transfer, hold and/or manage financials, etc. With that said, the relying party 112, in this exemplary embodiment, includes a banking institution, which has issued the payment account to the user 114. Other types of relying parties may be included in other system embodiments that are unrelated to banking services. For example, the relying party 112 may include other types of institutions that authenticate users associated with products and/or services offered by the institutions (e.g., institutions associated with insurance products and/or services, telecommunication products and/or services, entertainment products and/or services, investment products and/or services, education products and/or services, health products and/or services, email/communication products and/or services, etc.). As such, in general, the relying party 112 may include a business, a merchant, a retailer, a service provider (e.g., a healthcare provider, etc.), or another entity (which is or is not a banking institution) that interacts with users, whereby user authentication is relied upon for granting access to users to the transaction interface 118 or other interface(s) at the communication device 108, for example, via accounts associated with the user 114 (e.g., purchase accounts, email accounts, health accounts, insurance accounts, telecommunication accounts, entertainment accounts, investment accounts, etc.).

While only one IDP 102, one authorization network 104, one commerce platform 106, one communication device 108, one IPP 110, and one relying party 112 are illustrated in the system 100, it should be appreciated that additional ones of these parts may be included in other system embodiments. In addition, it should be appreciated that the system 100 is applicable to multiple users.

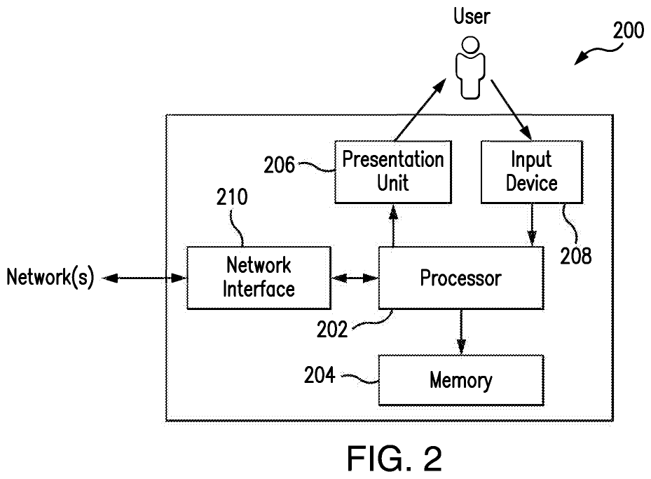

FIG. 2 illustrates an exemplary computing device 200 that can be used in the system 100 of FIG. 1. The computing device 200 may include, for example, one or more servers, workstations, personal computers, laptops, tablets, smartphones, etc. In addition, the computing device 200 may include a single computing device, or it may include multiple computing devices located in close proximity or distributed over a geographic region, so long as the computing devices are specifically configured to function as described herein. In the exemplary embodiment of FIG. 1, each of the IDP 102, the authorization network 104, the commerce platform 106, the one communication device 108, the IPP 110, and the relying party 112 may be considered, may include, and/or may be implemented in a computing device consistent with the computing device 200, coupled to (and in communication with) one or more of the networks illustrated in FIG. 1. However, the system 100 should not be considered to be limited to the computing device 200, as described below, as different computing devices and/or arrangements of computing devices may be used in other embodiments. In addition, different components and/or arrangements of components may be used in other computing devices.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, identity details and data related to identities of users, digital identities of users, biometric references for users, identifiers, tokens, other payment account credentials, Blockchain data structures, and/or other types of data (and/or data structures) suitable for use as described herein.

Furthermore, in various embodiments, computer-executable instructions may be stored in the memory 204 for execution by the processor 202 to cause the processor 202 to perform one or more of the functions described herein (e.g., one or more of the operations described in method 300, method 400, etc.), such that the memory 204 is a physical, tangible, and non-transitory computer readable storage media. Such instructions often improve the efficiencies and/or performance of the processor 202 and/or other computer system components configured to perform one or more of the various operations herein (e.g., in method 300, method 400, etc.), whereby the instructions when performed/executed effectively transform the computing device 200 into a special purpose device. It should be appreciated that the memory 204 may include a variety of different memories, each implemented in one or more of the functions or processes described herein.

In the exemplary embodiment, the computing device 200 also includes a presentation unit 206 that is coupled to (and is in communication with) the processor 202 (however, it should be appreciated that the computing device 200 could include output devices other than the presentation unit 206, etc.). The presentation unit 206 outputs information, visually or audibly, for example, to a user of the computing device 200 (e.g., prompts the user 114 at the communication device 108 to capture a biometric, to initiate a transaction, etc.), etc. And, various interfaces (e.g., as defined by the transaction interface 118, etc.) (e.g., including instructions to capture an image of a document, etc.) may be displayed at computing device 200, and in particular at presentation unit 206, to display certain information in connection therewith. The presentation unit 206 may include, without limitation, a liquid crystal display (LCD), a light-emitting diode (LED) display, an organic LED (OLED) display, an “electronic ink” display, speakers, etc. In some embodiments, the presentation unit 206 may include multiple devices.

In addition, the computing device 200 includes an input device 208 that receives inputs from the user (i.e., user inputs) of the computing device 200 such as, for example, biometrics, etc., in response to prompts from the transaction interface 118, etc., as further described below. The input device 208 may include a single input device or multiple input devices. The input device 208 is coupled to (and is in communication with) the processor 202 and may include, for example, one or more of a keyboard, a pointing device, a mouse, a camera, a touch sensitive panel (e.g., a touch pad or a touch screen, etc.), another computing device, and/or an audio input device. In various exemplary embodiments, a touch screen, such as that included in a tablet, a smartphone, or similar device, may behave as both the presentation unit 206 and the input device 208.

Further, the illustrated computing device 200 also includes a network interface 210 coupled to (and in communication with) the processor 202 and the memory 204. The network interface 210 may include, without limitation, a wired network adapter, a wireless network adapter (e.g., an NFC adapter, a Bluetooth™ adapter, etc.), a mobile network adapter, or other device capable of communicating to one or more different ones of the networks herein and/or with other devices described herein. Further, in some exemplary embodiments, the computing device 200 may include the processor 202 and one or more network interfaces incorporated into or with the processor 202.

Referring again to FIG. 1, the user 114 may request that a payment token be provisioned to the communication device 108 for use with his/her payment account in connection with performing a transaction with a merchant (not shown). For example, as part of performing the transaction, the user 114 may not want to provide a primary account number (PAN) for his/her payment account to the merchant. As such, the user 114 may request that a token be provisioned to his/her communication device 108 (as associated with the payment account) (e.g., by the commerce platform 106, etc.), whereby the user 114 can then instead provide the token to the merchant to initiate the transaction (e.g., through use of the transaction interface 118, etc.). In connection with generating such a payment token, for example, the user 114 may initially interact with the merchant, via the transaction interface 118, at his/her communication device 108. As part of this interaction (e.g., upon accessing the transaction interface 118, etc.), the communication device 108, as configured by the transaction interface 118, captures a biometric of the user 114 and generates a hashed biometric template (based on the captured biometric and a signature/fingerprint stored in the communication device 108).

The communication device 108 is configured to then transmit a tokenization request to the commerce platform 106 for the token prior to initiating the transaction (e.g., as a specified operation of the transaction interface 118 when performing such transaction, etc.). The tokenization request includes the hashed biometric template generated by the communication device 108 as well as device data unique to the communication device 108 (e.g., a MAC address, an ESN, a digital device identifier (DDI), etc.), the PAN for the user's payment account (as issued by the relying party 112 in this example), and additional personal identifying information (PII) or identity attributes for the user 114 (e.g., a mailing address, an email address, a phone number, a birthdate, etc.).

In turn, the commerce platform 106 is configured to transmit the tokenization request to the authorization network 104 (e.g., via the payment rails of the payment network associated with the commerce platform 106, etc.) to confirm/verify the identity of the user 114 (e.g., to confirm/verify that the user 114 is authorized to request the token, etc.). In this exemplary embodiment, the commerce platform 106 is configured to transmit the request to the authorization network 104, in whole or in part, via a 3DS platform 120 included in the authorization network 104. The 3DS platform 120 includes a directory server, for example, and is configured to interact with one or more merchant plugins (MPIs) and/or access control servers (ACSs) associated with banking institutions. In connection therewith, the 3DS platform 120 is configured, in connection with conventional authentication requests, to provide enhanced authentication of users (such as the user 114 in this example) as part of transactions performed by the users at merchants. In this embodiment, though, the 3DS platform 120 is specifically (or additionally, uniquely, etc.) configured (as a new operation of the 3DS platform 120) to distinguish the tokenization request received from the commerce platform 106 from a conventional authentication request (e.g., based on the content of the tokenization request (e.g., inclusion of the hashed biometric template, etc.), based on receipt of the tokenization request from the commerce platform 106, etc.) and pass the tokenization request (in whole or in part) to the IDP 102 (e.g., so that a digital identity of the user 114 may be used to authenticate the user 114 (without a direct interaction with the user 114), etc.). In response, the IDP 102 is configured to verify the hashed biometric template and/or the additional PII of the user 114 (or part thereof) (e.g., the mailing address, birthdate, email address, phone number, etc.), as included in the tokenization request, with the IPP 110 (via a digital identity of the user included at the IPP 110), via a request for verification. The IPP 110, consequently, then is configured to respond to the request for verification of the hashed biometric template and/or the additional PII with a verified or not verified response.

When the user 114 is verified, the IDP 102 is configured to derive at least one zero-knowledge proof (ZKP) parameter (e.g., at least one model, at least one value, at least one hash of an input, etc.) from the hashed biometric template, as well as from an identifier (e.g., a digital identifier, etc.) associated with the user 114 (or the user's payment account or the user's communication device 108) and/or the additional PII for the user 114 or a concatenation or other combination of the same. The identifier is generally derived from (or otherwise included in) the tokenization request (broadly, it is based on the tokenization request). For example, the identifier may be specific data included in the tokenization request (e.g., the MAC address, ESN or DDI for the communication device 108, the PAN for the user's payment account, etc.), or it may be derived therefrom or from the hashed biometric template included in the tokenization request. For example, the identifier may be generated by hashing the received data, or part thereof, as the key or input to the one-way hash function (e.g., SHA-2, etc.), etc., or as a unique universal identifier (UUID) (e.g., randomly generated, etc.), etc.

The IDP 102 is configured to then store the ZKP parameter in a ledger data structure 116 (which, in this embodiment, is a Blockchain data structure or other suitable type of data structure, etc.). The ZKP parameter is referenced, in the ledger data structure 116, by the identifier associated with the user 114 (e.g., at a node in the ledger data structure 116 defined by the identifier, etc.). The ledger data structure 116 may be a public data structure, in this example, whereby one or more additional entities may have access thereto. As such, it is apparent that the ZKP parameter is not revisable into the underlying data and not PII (e.g., the ZKP parameter may include a one-way hash of a one-way hash, etc.). That is, the particular technique(s) used in generating the ZKP parameter is not any particular technique, but the data has to be sufficiently obscured through the technique(s) to be published in the ledger data structure 116. Example techniques may include dividing the data into partial data (or subsets), and then hashing the partial data (or subset), whereby the hashed partial data is repeatably derived from the PII, yet not representative of the PII, as a whole. In connection therewith, then, the ZKP parameter(s) may be used to prove knowledge of the data from which the ZKP parameter(s) are derived (e.g., the hashed biometric template and/or additional PII from the tokenization request, etc.) (through use of the same technique(s)), despite the actual data being hidden. As such, use of the ZKP parameter(s) maintains user data privacy, particularly in distributed systems (as herein), while also allowing for use of such data to authenticate the user.

The IDP 102 is configured to then transmit the identifier to the 3DS Platform 120. And, when received, the 3DS Platform 120 is configured to return the identifier to the commerce platform 106. Optionally, the 3DS Platform 120 may be configured to initially transmit the identifier to the relying party 112 (or associated ACS) for approval (for approval to provision the token for the user's payment account, etc.). Then, after approval (in this optional scenario), the 3DS Platform 120 is configured to return the identifier to the commerce platform 106.

Upon receipt of the identifier associated with the user 114, the commerce platform 106 is configured to generate a token, which binds the device data (i.e., the data indicative of the communication device 108), the identifier of the user 114, and the PAN for the user's payment account. The commerce platform 106 is configured to then transmit the token to the communication device 108, which is configured, in turn, to store the token in connection with the transaction interface 118 (e.g., in a secure element (SE) associated with a virtual wallet application of communication device 108, a merchant specific application, or a merchant website, etc.), for use in subsequent transactions (including the transaction currently being initiated) to identify the user's payment account, via the transaction interface 118.

Subsequently, in connection with the current payment account transaction by the user 114 at the merchant, the communication device 108 is configured, by the transaction interface 118, to transmit an authentication request including the payment token (or a part thereof) along with the identifier of the user 114 (separately or as bound in the token), to the commerce platform 106 (through which the transaction is initiated). The authentication request may, potentially, further include a newly generated hashed biometric template for the user 114 which is accessible based on the user 114 being biometrically authenticated again at the communication device 108 (whereby the communication device 108 may require biometric authentication of the user 114 at the start of each transaction and generate a hashed biometric template for each transaction). Alternatively, the authentication request may include the hashed biometric template for the user 114 as previously generated for the user 114 (and stored either at the communication device 108 or at the commerce platform 106), yet still protected by a biometric authentication of the user 114 (e.g., where the hashed biometric is a reference, etc.) (whereby the same biometric template may be reused for the current transaction and subsequent transactions, indefinitely or for a defined interval, etc.).

In either case, the commerce platform 106, in turn, is configured to validate the token and to transmit the identifier, and potentially, the hashed biometric template for the user 114 (either received from the communication device 108 as part of the instant transaction or retrieved from memory 204 of the commerce platform 106 based on the prior interaction with the user 114 in connection with the tokenization request, etc.) to the authorization network 104, and specifically, the 3DS platform 120. It should be appreciated that, in some embodiments, the token or a part of the token may be maintained at the communication device 108, and not therefore transmitted as part of the authentication request to the commerce platform 106 (whereby the token may be maintained at the communication device 108, etc.).

In turn, the 3DS platform 120 is configured to transmit the identifier, and potentially, the hashed biometric template for the user 114, to the IDP 102. The IDP 102 is configured to generate at least one subsequent ZKP for the user 114 based on the identifier and the hashed biometric template for the user 114 (as included in the transmission from the 3DS platform 120 or retrieved from memory 204, when necessary). The IDP 102 is further configured to check or validate the generated subsequent ZKP against (or with) the previously generated ZKP parameter from the ledger data structure 116 (as located at a node in the ledger data structure 116 defined by the identifier, etc.). The IDP 102 is configured to verify the transmission from the 3DS platform 120 and/or the user 114 when the subsequent ZKP is validated or confirmed against the ledger data structure 116. When validated, the IDP 102 is configured to then transmit the identifier of the user 114 as verified (i.e., as a verified identifier) back to the 3DS platform 120 (generally, in response to the authentication request).

The 3DS platform 120, in turn, is configured to transmit the verified identifier to the relying party 112 (and specifically, an ACS associated therewith). The relying party 112 is configured to determine at least one further ZKP and to check, via an application programming interface (API) call, to the IDP 102, the immutability of the at least one further ZKP again based on the ZKP parameter in the ledger data structure 116 (again, at a node in the ledger data structure 116 defined by the identifier). The relying party 112 is configured to confirm the verification to the 3DS platform 120, which, in turn, is configured to indicate the strong verification in an accountholder authentication value (AAV) back to the commerce platform 106 (based on verification by the IDP 102 and by the relying party 112). Once received at the commerce platform 106, the transaction authorization may proceed with interactions between the commerce platform 106, the authorization network 104 and the relying party 112. In connection therewith, the relying party 112 is able to rely, at least in part, on the indication of the strong verification to permit the transaction to be authorized.

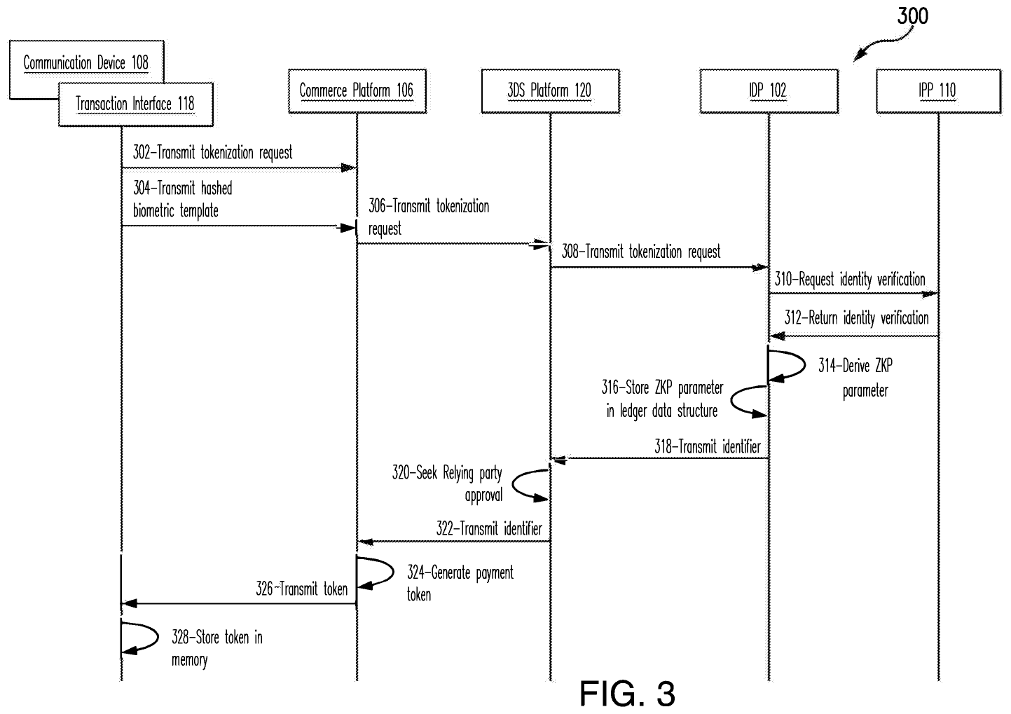

FIG. 3 illustrates an exemplary method 300 for use in provisioning a token to a user's communication device, based on a digital identity of the user 114. The exemplary method 300 is described as implemented in the IDP 102, the authorization network 104, the commerce platform 106, the communication device 108, the relying party 112, and other parts of system 100. The method 300 is also described with reference to the computing device 200. However, the methods herein should not be understood to be limited to the system 100 or the computing device 200, as the methods may be implemented in other systems and/or computing devices. Likewise, the systems and the computing devices herein should not be understood to be limited to the exemplary method 300.

Initially in the method 300, the user 114 seeks to provision a payment token to the communication device 108 for use in transactions initiated through the transaction interface 118 at a merchant (and/or at multiple other merchants). This may be done as part of a current transaction at the merchant, or it may be done by the user 114 as a separate interaction with the transaction interface 118 in advance of any transaction with the merchant. In either case, as explained above, the transaction interface 118 may include a merchant website or network-enabled application, or a wallet application associated with a payment network and/or banking institution. When the user 114 selects to provision the token (e.g., by selecting an option offered by the transaction interface 118, etc.), the communication device 108 (as directed by the transaction interface 118) transmits a tokenization request, at 302, to the commerce platform 106. The tokenization request includes device data specific to the communication device 108 (e.g., a MAC address, a DDI, etc.), a PAN for the user's payment account (i.e., as issued to the user 114 by the relying party 112) and, optionally, other identity-related information or attributes for the user 114 (e.g., a mailing address, an email address, a phone number, a birthdate, etc. (broadly, PII)).

In connection with the tokenization request, the communication device 108 also transmits, at 304, a hashed biometric template for the user 114 to the commerce platform 106. As part thereof, the communication device 108 prompts the user 114 to capture a biometric, such as a selfie or facial image or other biometric (via the input device 208), whereupon the communication device 108 captures the image (in this example) and converts the image to a biometric template. The communication device 108 further hashes the biometric template, by encoding the biometric template with a signature or fingerprint (e.g., stored in memory of the communication device 108 or provided by the user 114 as part of capturing the biometric, etc.). In this exemplary embodiment, the hash is a one-way hash, whereby the biometric template is not able to be reconstructed by another device from the hashed biometric template. With that said, the hashed biometric template may be included in (e.g., as part of, etc.) the tokenization request or it may be transmitted to the commerce platform 106 separate therefrom, yet still identified to (or linked to) the communication device 108, whereby it may also be identified to the tokenization request received from the communication device 108.

Upon receipt of the tokenization request (and hashed biometric template), the commerce platform 106 transmits, at 306, the tokenization request to the authorization network 104, and specifically, to the 3DS platform 120 included therein. The 3DS platform 120 recognizes or identifies the tokenization request (as distinct from a 3DS authentication request) (e.g., based on the content of the request such as the device identifier from the user's communication device 108, based on an indication received from the commerce platform 106 identifying the request as a tokenization request, etc.) and transmits, at 308, the tokenization request along to the IDP 102 (as an operation not conventional for the 3DS platform 120).

In response, the IDP 102 requests verification of one or more identity attributes of the user 114 from the IPP 110, at 310, for example, as included in the tokenization request (e.g., one or more PII attributes of the user 114 included in the underlying tokenization request, etc.). The IPP 110, in turn, verifies the identity attribute(s) of the tokenization request, including, for example, a name, a mailing address, email address, phone number, and/or birthdate, etc. It should be appreciated that the IDP 102 will provide sufficient detail (or combination of details) to the IPP 110 to enable the IPP 110 to identify the user 114 (e.g., a name and date of birth, etc.) and then to also enable the verification of the identity attribute(s) for the user 114. The attribute(s) are verified based on identity data associated with the user 114, as stored at (or accessible to) the IPP 110 (e.g., a DMV record for the user 114, a mobile telephone account record, etc.). And, once verified, the IPP 110 returns, at 312, a verification of the identity attribute(s) to the IDP 102 (e.g., a verified indicator or a not verified indicator, a green indicator for verified and a red indicator for not verified, a one indicator for verified and a zero indicator for not verified, etc.).

Next in the method 300, the IDP 102 derives, at 314, at least one ZKP parameter (e.g., a model, a value, etc.) from the hashed biometric template and an identifier associated with the user 114 (e.g., an identifier included in the tokenization request, a digital identifier included in the tokenization request, an identifier for the user 114 as assigned by the IDP 102 or other entity or part of the system 100, etc.), and potentially also on additional PII for the user 114 included in the tokenization request (e.g., as received from the hashed biometric template, from the tokenization request, etc.). In one example, the ZKP parameter is derived, by the IDP 102, as a concatenation of data elements including the hashed biometric template, the identifier, and various identity attributes of the user 114, which is then further hashed by a signature or fingerprint known to the IDP 102 (whereby the ZKP parameter may be derived repeatedly given the correct data elements). It should be appreciated that the ZKP parameter may be derived by other suitable mathematical operations. The IDP 102 then stores, at 316, the ZKP parameter in the ledger data structure 116, referenced by the identifier.

Next, the IDP 102 transmits, at 318, the identifier associated with the user 114 back to the 3DS platform 120. Upon receipt, the 3DS platform 120 seeks approval from the relying party 112 (i.e., the issuer of the payment account issued to the user 114 in this example), at 320, for the ZKP parameter to be used in authentication of the user 114 and/or the provisioning of the payment token to the communication device 108. When approved, the 3DS platform 120 transmits, at 322, the identifier to the commerce platform 106 together with the tokenization request for the token.

The commerce platform 106, in turn, generates, at 324, a payment token for the user 114, which binds the identifier of the user 114, the device data for the user's communication device 108, and the PAN for the user's payment account (as included in the tokenization request). The token is then transmitted, by the commerce platform 106, to the communication device 108 (potentially, along with the identifier for the user 114), at 326, and stored, at 328, in memory (e.g., in a SE associated with the memory 204, etc.) of the communication device 108 (e.g., in association with the identifier for the user 114, etc.), whereby the communication device 108 is provisioned with the payment token.

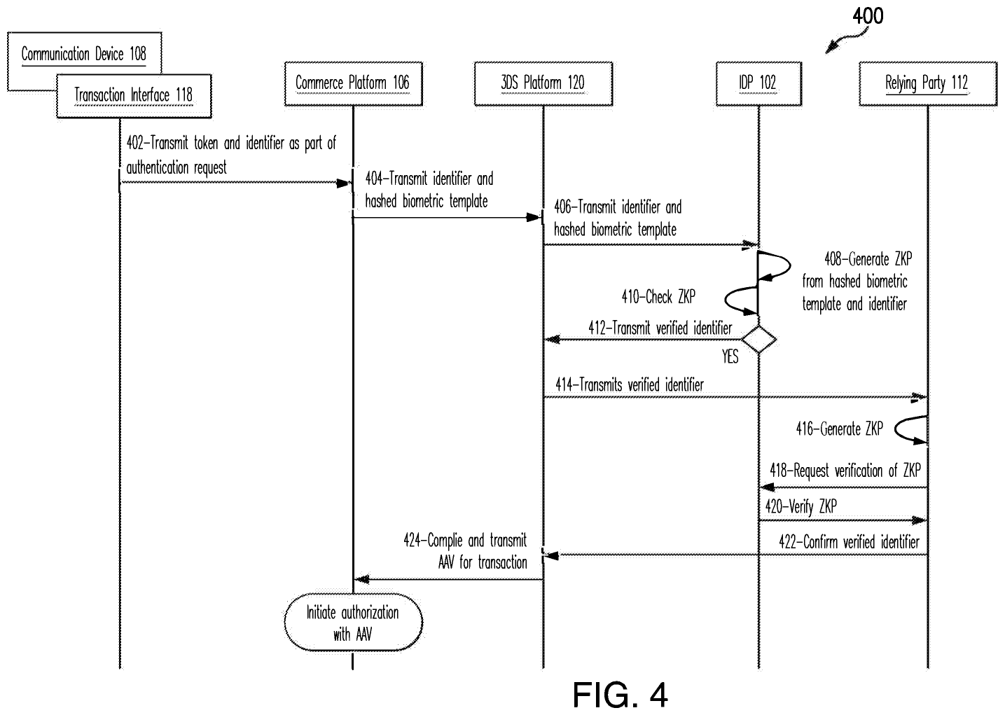

FIG. 4 illustrates an exemplary method 400 for use in authenticating a user in connection with a network transaction. The exemplary method 400 is described as implemented in the IDP 102, the authorization network 104, the commerce platform 106, the communication device 108, the relying party 112, and other parts of system 100. The method 400 is also described with reference to the computing device 200. However, the methods herein should not be understood to be limited to the system 100 or the computing device 200, as the methods may be implemented in other systems and/or computing devices. Likewise, the systems and the computing devices herein should not be understood to be limited to the exemplary method 400.

In connection with a subsequent transaction by the user 114 (e.g., after the token is provisioned to the user's communication device 108 via method 300, etc.), the user 114 interacts with the transaction interface 118, as a front-end, to purchase a product from a merchant (e.g., via an online transaction, etc.), whereby the user 114 initiates a payment account transaction to be funded by the user's payment account as identified by the payment token. In connection therewith, the communication device 108 (as controlled by the transaction interface 118) transmits, at 402, an authentication request for the transaction, including the payment token and the corresponding identifier associated with the user 114 (as linked to or derived from the token), to the commerce platform 106 (and, potentially, a hashed biometric template for the user 114, for example, as generated by the communication device 108 in connection with authenticating the user 114 as part of performing the current transaction, etc.).

The commerce platform 106 receives the payment token and the identifier and, at 404, transmits the authentication request, or at the least, the identifier and the hashed biometric template for the user 114 therefrom, to the authorization network 104, and in particular, to the 3DS platform 120. It should be appreciated that, in various embodiments, the hashed biometric template may be received from the communication device 108 as part of or in connection with the authentication request and the underlying transaction, or it may be retrieved from memory 204 of the commerce platform 106 based on the prior tokenization request. In still other embodiments, the hashed biometric template may not be transmitted with the authentication request at all, but may later be retrieved from memory by the IDP 102, whereby the hashed biometric template is not communicated or transmitted in connection with the authentication request. It should be further appreciated that the token or a part of the token may be maintained at the communication device 108, and not therefore transmitted as part of the authentication request to the commerce platform 106 (or from the commerce platform to the 3DS platform 120, etc.), whereby only the identifier may be transmitted.

In turn, the 3DS platform 120 transmits, at 406, the identifier and the hashed biometric template to the IDP 102. The IDP 102 generates, at 408, a subsequent ZKP based on the hashed biometric template and the identifier received from the 3DS platform 120. Thereafter, the IDP 102 accesses the ledger data structure 116 and checks, at 410, the subsequent ZKP against the ledger data structure 116 referenced by the identifier (and the ZKP parameter stored therein). With that said, the subsequent ZKP is generated in the same manner as described at operation 314 in the method 300.

When the check of the subsequent ZKP is successful, the IDP 102 transmits a verified identifier to the 3DS platform 120, at 412 (e.g., the identifier received from the user 114 with an indication that it has been verified, etc.). The 3DS platform 120 then transmits the verified identifier to the relying party 112, at 414 (and potentially the hashed biometric template, unless already known to the relying party 112). In response, the relying party 112 generates, at 416, a further ZKP based on the hashed biometric template for the user 114 and the verified identifier received from the 3DS platform 120. The further ZKP is derived in the same manner as described at operation 314 in the method 300, thereby permitting the further ZKP to be checked against the ledger data structure 116. Thereafter, the relying party 112 requests verification of the derived further ZKP against the ZKP parameter stored in the ledger data structure 116 and referenced by the identifier, at 418, via an API call to the IDP 102. The IDP 102 in turn checks the further ZKP (and immutability thereof) against the ZKP parameter stored in the ledger data structure 116 and, when the check is successful, confirms the same, at 420, to the relying party 112. And, the relying party 112 confirms the verified identifier, at 422, to the 3DS platform 120.

It should be appreciated that the verification of the ZKP in steps 416-420 may be optional in various embodiments. That is, the relying party 112 may rely on the verification from the 3DS platform and proceed to step 422 without separately verifying the ZKP, whereby certain data may be reserved from the relying party 112.

Regardless, upon the confirmation of the verified identifier of the user 114, the 3DS platform 120 compiles an AAV and transmits the AAV to the commerce platform 106, at 424. In response, the commerce platform 106 initiates authorization of the transaction. Specifically, the commerce platform 106 appends the AAV to an authorization request for the transaction and transmits the authorization request toward the relying party 112 (via the authorization network 104 (as part of a payment network, etc.)), where the request includes the AAV and the payment token for the user's payment account.

In view of the above, the systems and methods herein provide for verification of digital identities of users through use of zero-knowledge proof parameters, whereby personal identification information may be preserved. In particular, token providers are enabled to provide tokenization services to merchants and wallet applications, whereby the identity of users requesting such tokens may be verified with an Identity Issuing Authority before the tokens are generated and whereby specific devices, PANs, and identities may be bound into the tokens. In general, the tokens provide a common consumer authentication mechanism across multiple different platforms, banks, merchants, etc. What's more, in various embodiments, the users' authentication credentials (e.g., the tokens, biometric templates, etc.) are maintained in the respective devices of the users and not shared therefrom (e.g., unless hashed or otherwise obscured, etc.). Based on the above, then, the systems and methods herein may permit presentation of biometrics at various different devices, while the same user identifier may be persistently used across multiple different platforms, banks, merchants, etc. The identifier, then, is derived and therefore not personal identifying information itself.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one or more of the following operations: (a) receiving, by a computing device, a tokenization request associated with a payment account of a user, the tokenization request including a first biometric template for a biometric of the user; (b) deriving, by the computing device, at least one zero-knowledge proof (ZKP) parameter based on at least the first biometric template and an identifier associated with the user and/or the payment account; (c) storing, by the computing device, the at least one ZKP parameter in a ledger data structure, whereby the at least one ZKP parameter is referenced by the identifier; (d) after storing the at least one ZKP parameter in the ledger data structure, receiving an authentication request for a transaction by the user at a merchant, the authentication request including the identifier; (e) generating, by the computing device, at least one subsequent ZKP based on at least a second biometric template associated with the user and the identifier included in the authentication request; (f) checking, by the computing device, the at least one subsequent ZKP against the at least one ZKP parameter stored in the ledger data structure; and (g) transmitting, by the computing device, a verified identifier for the user to an authorization network in response to the authentication request when the check of the at least one subsequent ZKP is successful, whereby the authorization network initiates authorization of the transaction based at least in part on the verified identifier.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in tokenizing credentials for users based on digital identities of the users, the method comprising:
receiving, by a computing device, a tokenization request associated with a payment account of a user, the tokenization request including a first biometric template for a biometric of the user;
deriving, by the computing device, at least one zero-knowledge proof (ZKP) parameter based on at least the first biometric template and an identifier associated with the user and/or the payment account;
storing, by the computing device, the at least one ZKP parameter in a ledger data structure, whereby the at least one ZKP parameter is referenced by the identifier; and
after storing the at least one ZKP parameter in the ledger data structure:
receiving an authentication request for a transaction by the user at a merchant, the authentication request including the identifier;
generating, by the computing device, at least one subsequent ZKP based on at least a second biometric template associated with the user and the identifier included in the authentication request;
checking, by the computing device, the at least one subsequent ZKP against the at least one ZKP parameter stored in the ledger data structure; and
in response to the check of the at least one subsequent ZKP being successful, transmitting, by the computing device, a verified identifier for the user to an authorization network, whereby the authorization network initiates authorization of the transaction based at least in part on the verified identifier.

2. The computer-implemented method of claim 1, wherein each of the first and second biometric templates is a hashed biometric template; and
wherein the identifier includes one of hashed data associated with the user and a unique universal identifier (UUID) for the user.

3. The computer-implemented method of claim 2, wherein the hashed biometric template is a one-way hashed biometric template, whereby the biometric template is not able to be reconstructed from said hashed biometric template.

4. The computer-implemented method of claim 1, further comprising, after storing the at least one ZKP parameter in the ledger data structure:
receiving, by the computing device, at least one further ZKP from a relying party associated with the payment account;
checking, by the computing device, the at least one further ZKP against the at least one ZKP parameter stored in the ledger data structure; and
in response to the check of the at least one further ZKP being successful, confirming, by the computing device, the verified identifier to the relying party.

5. The computer-implemented method of claim 1, wherein the tokenization request further includes identifying data for the user, the identifying data including a birthdate, a gender, and a phone number of the user; and
wherein the at least one ZKP parameter stored in the ledger data structure is further based on the identifying data of the user.

6. The computer-implemented method of claim 5, further comprising verifying, by the computing device, the identifying data of the user, included in the tokenization request, with at least one identity proofing platform before deriving the at least one ZKP parameter.

7. The computer-implemented method of claim 1, wherein the authentication request further includes the second biometric template.

8. A non-transitory computer-readable storage medium including executable instructions, which when executed by at least one processor, cause the at least one processor to:
receive a tokenization request associated with a payment account of a user, the tokenization request including a first biometric template for a biometric of the user;
derive at least one zero-knowledge proof (ZKP) parameter based on at least the first biometric template and an identifier associated with the user and/or the payment account;
store the at least one ZKP parameter at a node in a ledger data structure defined by the identifier; and then
receive an authentication request for a transaction by the user at a merchant, the authentication request including the identifier and a second biometric template associated with the user;
generate at least one subsequent ZKP based on at least the second biometric template and the identifier;
compare the at least one subsequent ZKP to the at least one ZKP parameter stored in the ledger data structure; and
in response to a match of the at least one subsequent ZKP to the at least one ZKP parameter, transmit a verified identifier for the user to an authorization network, whereby the authorization network initiates authorization of the transaction based at least in part on the verified identifier.

9. The non-transitory computer-readable storage medium of claim 8, wherein the executable instructions, when executed by the at least one processor, further cause the at least one processor to:
receive at least one further ZKP from a relying party associated with the payment account;
compare the at least one further ZKP against the at least one ZKP parameter stored in the ledger data structure; and
in response to a match of the at least one further ZKP to the at least one ZKP parameter, confirm the verified identifier to the relying party.

10. The non-transitory computer-readable storage medium of claim 9, wherein the tokenization request further includes identifying data for the user, the identifying data including a birthdate, a gender, and a phone number of the user; and
wherein the executable instructions, when executed by the at least one processor, cause the at least one processor to derive the at least one ZKP parameter further based on the identifying data of the user.

11. The non-transitory computer-readable storage medium of claim 10, wherein the executable instructions, when executed by the at least one processor, further cause the at least one processor to verify the identifying data of the user, included in the tokenization request, with at least one identity proofing platform before deriving the at least one ZKP parameter.

12. The non-transitory computer-readable storage medium of claim 9, wherein the first biometric template and the second biometric template are both hashed biometric templates; and
wherein the identifier includes a unique universal identifier (UUID) for the user.

13. The non-transitory computer-readable storage medium of claim 12, wherein the hashed biometric templates are one-way hashed biometric templates, whereby the biometric templates are not able to be reconstructed from said hashed biometric templates.

14. A system for tokenizing credentials for users based on digital identities of the users, the system comprising a computing device configured to:
receive a tokenization request associated with a payment account of a user, the tokenization request including a first biometric template for a biometric of the user;
derive at least one zero-knowledge proof (ZKP) parameter based on at least the first biometric template and an identifier associated with the user and/or the payment account;
store the at least one ZKP parameter at a node in a ledger data structure defined by the identifier;
receive an authentication request for a transaction by the user at a merchant, the authentication request including the identifier and a second biometric template associated with the user;
generate at least one subsequent ZKP based on at least the second biometric template and the identifier;
compare the at least one subsequent ZKP to the at least one ZKP parameter stored in the ledger data structure; and
in response to a match of the at least one subsequent ZKP to the at least one ZKP parameter, transmit a verified identifier for the user to an authorization network, whereby the authorization network initiates authorization of the transaction based at least in part on the verified identifier.

15. The system of claim 14, wherein the computing device is further configured to:
receive at least one further ZKP from a relying party associated with the payment account;
compare the at least one further ZKP against the at least one ZKP parameter stored in the ledger data structure; and
in response to a match of the at least one further ZKP to the at least one ZKP parameter, confirm the verified identifier to the relying party.

16. The system of claim 15, wherein the tokenization request further includes identifying data for the user, the identifying data including a birthdate, a gender, and a phone number of the user; and
wherein the computing device is configured to derive the at least one ZKP parameter further based on the identifying data of the user.

17. The system of claim 16, wherein the computing device is further configured to verify the identifying data of the user, included in the tokenization request, with at least one identity proofing platform before deriving the at least one ZKP parameter.

18. The system of claim 15, wherein the first biometric template and the second biometric template are hashed biometric templates.

19. The system of claim 18, wherein the hashed biometric templates are one-way hashed biometric templates, whereby the biometric templates are not able to be reconstructed from said hashed biometric templates.

20. The system of claim 14, wherein the identifier includes one of hashed data associated with the user or a unique universal identifier (UUID) for the user
